(19) United States
(12) Patent Application Publication
(10) Pub. No.: US 2022/0219460 A1
(43) Pub. Date: Jul. 14, 2022

(54) ADJUSTABLE PRINT SUBSTANCE DETECTOR

(71) Applicant: Hewlett-Packard Development Company, L.P., Spring, TX (US)

(72) Inventors: Jody L. Clayburn, Vancouver, WA (US); Russell Sterling Sauer, Vancouver, WA (US); Robert Yraceburu, Vancouver, WA (US)

(73) Assignee: Hewlett-Packard Development Company, L.P., Spring, TX (US)

(21) Appl. No.: 17/288,528

(22) PCT Filed: Sep. 6, 2019
(86) PCT No.: PCT/US2019/049857

§ 371 Date: Apr. 24, 2021

(51) Int. Cl. B41J 2/175

(52) U.S. Cl. CPC B41J 2/17566; B41J 2002/17579; B41J 2/17546

(57) ABSTRACT

In one example, a print substance detector can include a sensor pin, an actuator coupled to the sensor pin to adjust a distance between a surface of the sensor pin and a base portion of a print substance reservoir, and a controller to send instructions to the actuator to adjust the distance of the sensor pin based on an indication of an operation associated with the print substance reservoir.

### BACKGROUND

Fluid level detectors can be utilized to determine a fluid level within a container. In some examples, fluid detectors can utilize a conductive liquid level sensor that utilizes a level of conductivity generated by a particular quantity of liquid surrounding the fluid detector. For example, a relatively higher level of liquid can correspond to a first level of conductivity and a relatively lower level of liquid can correspond to a second level of conductivity. In this way, the fluid detector can determine the level of a liquid within a container.

### BRIEF DESCRIPTION OF THE DRAWINGS

FIG. 1 is an example system for an adjustable print substance detector consistent with the present disclosure.

FIG. 2 is an example system for an adjustable print substance detector consistent with the present disclosure.

FIG. 3 is an example system for an adjustable print substance detector consistent with the present disclosure.

FIG. 4 is an example system for an adjustable print substance detector for a fill operation consistent with the present disclosure.

FIG. 5 is an example system for an adjustable print substance detector for a drain operation consistent with the present disclosure.

### DETAILED DESCRIPTION

In some examples, a printing device can generate an image such as text, pictures, or other features on a print medium. As used herein, a print medium can include a material that can receive a print substance from a printing device. For example, a print medium can include, but is not limited to paper, plastic, metal, among other materials. In some examples, the printing device can deposit the print substance on to specific locations of a print medium to generate the image. As used herein, a print substance can include a compound that can be deposited on the print medium by the printing device. For example, the print substance can include ink, toner, three dimensional (3D) print ink, and/or other materials that can be deposited on a print medium to generate an image.

In some examples, the printing device can utilize a reservoir to store the print substance. For example, the reservoir can be an enclosure that can receive and enclose ink that can be utilized by an inkjet printing device. In this example, the reservoir can be filled to store additional print substance or store a relatively large quantity of print substance for the printing device. In this example, the reservoir can be drained to reclaim unused print substance at the end of a workable life of a printing device. In this way, the reservoir can be utilized to provide continuous print substance with relatively less waste compared to previous systems.

In some examples, a conductive sensor can be positioned within the reservoir to determine the level of print substance stored within the reservoir. As used herein, a conductive sensor can include a device with a power source to provide power across electrodes to detect a resistance between the electrodes. In some examples, different levels of print substance can correspond to different resistance levels, which can be utilized to determine a quantity of print substance within the reservoir. In previous systems, a fixed conductive sensor can be utilized within a reservoir and extend from a top surface to a bottom surface of the reservoir. In some examples, the fixed conductive sensor can have a relatively low accuracy level, which can make it difficult to determine precise and/or accurate print substance levels.

The present disclosure relates to an adjustable print substance detector that can be adjusted to different heights within the reservoir. For example, a conductive sensor can be coupled to an actuator or motorized mechanism to raise or lower the conductive sensor to different levels within the reservoir. In some examples, the conductive sensor can be a sensor pin. As used herein, a sensor pin can include a sensor that is capable of providing an input voltage or current and/or receiving an output voltage or current. In some examples, the voltage or current provided by the sensor pin or detected by the sensor pin can include other signals, such as, but not limited to: waveform signals, pulse signals, and/or other types of signals that can be generated and received through a print substance. In some examples, the actuator can be utilized to adjust the sensor to a particular level such that a tip portion or end of the sensor is positioned at a particular level within the reservoir. In this way, the adjustable sensor can be positioned at a particular level within the reservoir to determine when the particular level is reached by the print substance which can be utilized to more accurately determine the level of the print substance within the reservoir.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

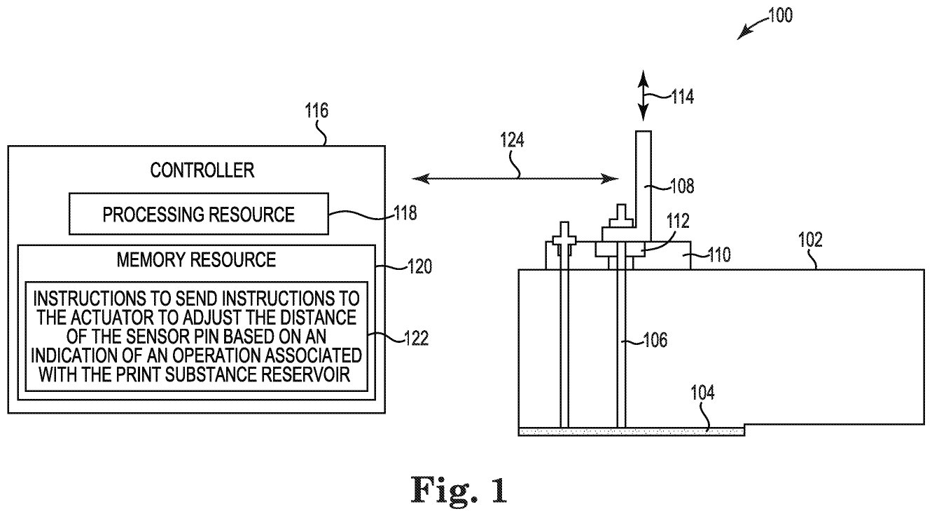

FIG. 1 is an example system 100 for an adjustable print substance detector consistent with the present disclosure. In some examples, the system 100 can be a part of a print substance detection system positioned within a printing device. For example, the system 100 can be part of an inkjet printing device that can utilize a print substance 104 stored within a print substance reservoir 102. Although a print substance reservoir 102 that is capable of storing a print substance 104 is illustrated, examples of the present disclosure are not so limited. For example, other types of enclosures that are utilized to store materials could be implement the systems and devices described herein. In some examples, the print substance reservoir 102 can be an enclosure or container that can receive and store the print substance 104. As described herein, the print substance 104 can be a compound that can be utilized by a printing device to generate images on a print medium. These compounds can include, but are not limited to, ink, toner, three-dimensional printing fluid, among other compounds. For example, the print substance 104 can be an ink substance that can be deposited on a print medium to generate an image on the print medium.

In some examples, the system 100 can include a sensor pin 106 that is coupled to an actuator 108. As used herein, an actuator 108 can be a mechanical device to control movement of a device or system. In some examples, the actuator 108 can be utilized to move the sensor pin 106 in the directions of double arrow 114. For example, the actuator 108 can be coupled to the sensor pin 106 and move in the direction of double arrow 114 to move the sensor pin 106 to a particular level within the print substance reservoir 102. In some examples, the actuator 108 can be a motorized pulley system that can utilize a cord coupled to the sensor pin 106 and a motor to extend and retract the cord to alter the position of the sensor pin 106 within the print substance reservoir 102. In other examples, the actuator 108 can include a hydraulic, pneumatic, or electric actuator that can be coupled directly or indirectly to the sensor pin 106 to alter the position of the sensor pin 106 in the direction of double arrow 114.

In some examples, the system 100 can include a base portion 110 to couple the actuator 108 to the print substance reservoir 102. In some examples, the base portion 110 can be utilized to support the actuator 108 and/or system associated with the actuator 108. In some examples, the base portion 110 can be coupled to an exterior portion of the print substance reservoir 102. For example, the print substance reservoir 102 can include an interior portion to store the print substance 104 and an exterior portion that is opposite of the interior portion. In some examples, the base portion 110 can be utilized to position the sensor pin 106 at a particular angle with respect to the print substance reservoir 102. In some examples, the angle of the sensor pin 106 can be utilized to determine a level of the sensor pin 106. For example, the angle of the sensor pin 106 can change the level or position of the tip of the sensor pin 106 as the actuator 108 moves the sensor pin 106 in the directions of double arrow 114. Thus, in some examples, the controller 116 can utilize the angle of the sensor pin 106 provided by the base portion 110 to calculate a more precise level of a tip portion of the sensor pin 106.

In some examples, the sensor pin 106 can extend from the exterior portion of the print substance reservoir 102 to the interior portion of the print substance reservoir 102. In these examples, the system 100 can include an aperture to allow the sensor pin 106 to extend from the exterior position to the interior position of the print substance reservoir 102. In some examples, the system 100 can include a seal 112 to prevent the print substance 104 from passing through the aperture utilized to allow the sensor pin 106 to extend from the exterior position to the interior position of the print substance reservoir 102. As used herein, the seal 112 can be a liquid tight barrier that allows the sensor pin 106 to move in the directions of double arrow 114 without allowing a liquid to pass through. For example, the seal 112 can be a rubber grommet that can surround the sensor pin 106 to create a liquid tight seal around the sensor pin 106.

In some examples, the system 100 can include a controller 116 communicatively coupled to the actuator 108. In some examples, the controller 116 can be utilized to control particular functions of a printing device that includes or is coupled to the print substance reservoir 102. In some examples, the controller 116 can be connected to the actuator 108 through a communication path 124. For example, the controller 116 can be connected to the actuator 108 through a wired or wireless communication connection. In some examples, the communication path 124 can be utilized by the controller 116 to alter the position of the sensor pin 106 as described herein. For example, the controller 116 can send instructions through the communication path 124 to the actuator 108 to make the actuator 108 alter the position of the sensor pin 106.

In some examples, the controller 116 can include a processing resource 118 and/or a memory resource 120 storing instructions to perform particular functions. A processing resource 118, as used herein, can include a number of processing resources capable of executing instructions stored by a memory resource 120. The instructions (e.g., machine-readable instructions (MRI), computer-readable instructions (CRI), etc.) can include instructions stored on the memory resource 120 and executable by the processing resource 118 to perform or implement a particular function. The memory resource 120, as used herein, can include a number of memory components capable of storing non-transitory instructions that can be executed by the processing resource 118.

The memory resource 120 can be in communication with the processing resource 118 via a communication link (e.g., communication path). The communication link can be local or remote to an electronic device associated with the processing resource 118. The memory resource 120 includes instructions 122. The memory resource 120 can include more or fewer instructions than illustrated to perform the various functions described herein. In some examples, instructions (e.g., software, firmware, etc.) can be downloaded and stored in memory resource 120 (e.g., MRM) as well as a hard-wired program (e.g., logic), among other possibilities. In other examples, the controller 116 can be hardware, such as an application-specific integrated circuit (ASIC), that can include instructions to perform particular functions.

The controller 116 can include instructions 122, that when executed by a processing resource 118 can send instructions to the actuator 108 to adjust the distance of the sensor pin 106 based on an indication of an operation associated with the print substance reservoir 102. As described herein, the controller 116 can send the instructions to the actuator 108 through a communication path 124. In some examples, the actuator 108 can adjust the distance of the sensor pin 106 to a particular level within the print substance reservoir 102 to determine when a particular change in the level of the print substance 104 has occurred. For example, the actuator 108 can adjust the distance to a relatively higher level to determine when the addition of the print substance 104 has reached the relatively higher level.

In some examples, the controller 116 can receive an instruction that a particular operation is to be performed that is associated with the print substance reservoir 102. As used herein, an operation associated with the print substance reservoir 102 can include an action that can correspond to an increase or decrease in the level of the print substance 104 within the print substance reservoir 102. For example, the operation can include a filling operation, a draining operation, and/or a storage operation. In this example, a filling operation can include an action of adding a quantity of print substance 104 to the print substance reservoir 102. In addition, a draining operation can include an action of removing a quantity or transporting a quantity of print substance 104 from the print substance reservoir 102. Furthermore, a storage operation can include an action to maintain a level of print substance 104 within the print substance reservoir 102 for a quantity of time.

In some examples, the system 100 can be utilized to more precisely identify changes in the level of the print substance 104 stored within the print substance reservoir 102. For example, the actuator 108 can be utilized to alter the position of the sensor pin 106 to a specific location and notify the controller 116 when the print substance 104 reaches a tip portion of the sensor pin 106. In this way, the sensor pin 106 can be utilized to determine the presence or the absence of the print substance 104 and be more precise when determining the level of the print substance 104 within the print substance reservoir 102. As described herein, previous systems can utilize a conductive sensor such as the sensor pin 106 to determine the level of a print substance 104 through a calculation utilizing the conductivity between electrodes of the conductive sensor. However, this calculation can be less accurate or precise than utilizing the sensor pin 106 to determine the presence or absence of the print substance 104 at a particular level adjusted by the actuator 108.

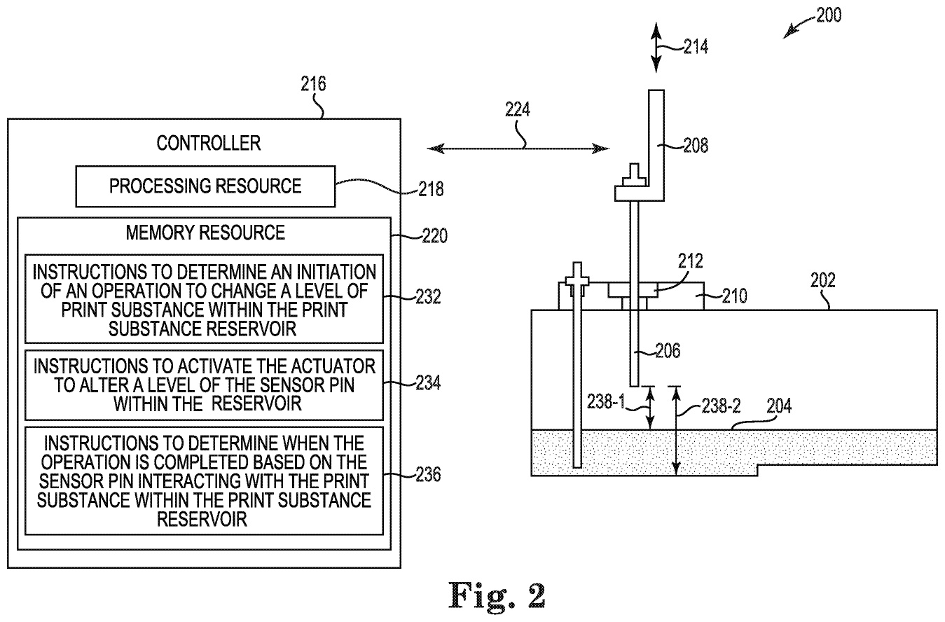

FIG. 2 is an example system 200 for an adjustable print substance detector consistent with the present disclosure. In some examples, the system 200 can include the same or similar elements as system 100 as referenced in FIG. 1. For example, the system 200 can be part of a printing device and include a print substance reservoir 202 that includes a print substance 204. In addition, the system 200 can include a sensor pin 206 coupled to an actuator 208 to alter the position of the sensor pin 206 within the print substance reservoir 202. In some examples, the system 200 can include a base portion 210 that can include a seal 212 to prevent the print substance 204 from passing through the aperture to the exterior of the print substance reservoir 202.

As described herein, the actuator 208 can be communicatively coupled to a controller 216 through a communication path 224. In some examples, the controller 216 can send instructions to the actuator 208 through the communication path 224 and/or the sensor pin 206 can send sensor data to the controller 216. As used herein, sensor data can include information sensed by the sensor pin 206. For example, the sensor data can include a particular conductivity between electrodes of the sensor pin 206. In other examples, the sensor data can include an indication of the presence or absence of print substance 204 contacting the surface of the sensor pin 206.

In some examples, the controller 216 can be the same or similar device as controller 116 as referenced in FIG. 1. For example, the controller 216 can include a processing resource 218 and a memory resource 220 storing instructions 232, 234, 236 that can be executed by the processing resource 218 to perform particular functions. The controller 216 can include instructions 232, that when executed by a processing resource 218 can determine an initiation of an operation to change a level of print substance 204 within the print substance reservoir 202.

In some examples, the controller 216 can receive an indication that an operation to change the level of the print substance 204 is to be performed. For example, the controller 216 can receive an indication that print substance 204 is to be added to the print substance reservoir 202. In this example, the controller 216 can receive authentication information from a filling device to open a filling aperture. As used herein, a filling aperture can include an aperture to receive additional print substance 204 from a filling device. In other examples, the controller 216 can receive an indication that a portion of the print substance 204 is to be drained from the print substance reservoir 202. For example, the controller 216 can receive an indication that a portion of the print substance 204 is to be removed from the print substance reservoir 202 to reuse the print substance 204 with a different printing device.

The controller 216 can include instructions 234, that when executed by a processing resource 218 can activate the actuator 208 to alter a level of the sensor pin 206 within the print substance reservoir 202. In some examples, the sensor pin 206 can be positioned at a level of the print substance 204 and in response to the actuator 208 receiving the instruction from the controller 216 can be raised a distance 238-1 above the level of the print substance 204. In some examples, the instructions provided to the actuator 208 can be an indication that a fill operation is to be performed. As described herein, a fill operation can include an addition of a quantity of print substance 204 to the print substance reservoir 202.

In some examples, the distance 238-1 can correspond to a predicted or authorized quantity of print substance 204 to be added to the print substance reservoir 202 during a particular fill operation. For example, the controller 216 can receive an indication of a fill operation and send instructions through the communication path 224 to the actuator 208. In this example, the instructions can indicate the distance 238-1 and the actuator can move the sensor pin 206 in an upward direction of double arrow 214 as illustrated in FIG. 2. In this example, the controller 216 can authorize the filling operation to proceed or begin when the sensor pin 206 has been moved the distance 238-1. In this example, the sensor pin 206 can be utilized to determine when the fill operation should end based on an indication that the print substance 204 is present at the adjusted level.

In some examples, the distance 238-1 can correspond to a particular quantity of print substance 204 to be added to the print substance reservoir 204. For example, the controller 216 can authorize that a particular quantity of print substance 204 is to be added to the print substance reservoir 202. In this example, the controller 216 can determine the distance 238-1 and/or distance 238-2 that will be reached by the print substance 204 within the print substance reservoir 202 with the addition of the particular quantity of print substance 204.

The controller 216 can include instructions 236, that when executed by a processing resource 218 can determine when the operation is completed based on the sensor pin 206 interacting with the print substance 204 within the print substance reservoir 202. As described herein, the controller 216 can send instructions to the actuator 208 to raise the level of the sensor pin 206 a distance 238-1 or to a distance 238-2 from a base or bottom of the print substance reservoir 202. In some examples, the controller 216 can determine that a fill operation is completed when the print substance 204 level within the print substance reservoir 202 reaches the sensor pin 206. In a similar way, the controller 216 can alter the position of the sensor pin 206 to a lower level than a current level of the print substance 204. In this example, the operation can be a drain operation and the controller 216 can determine that the drain operation has completed when the sensor pin 206 detects an absence of print substance 204 at the altered level of the sensor pin 206.

The system 200 can be part of a printing device or utilized by a printing device to more accurately monitor a level of print substance 204 within a print substance reservoir 202. In addition, the system 200 can be utilized to more closely monitor changes in the level of the print substance 204 within the print substance reservoir 202 by continually adjusting the level of the sensor pin 206 to the level of the print substance 204. For example, the controller 216 can adjust the level of the sensor pin 206 to a point when the sensor pin 206 detects the level of print substance 204 and identify relatively small changes in the level of print substance 204 (e.g., the level of print substance 204 drops below the sensor pin 206, etc.).

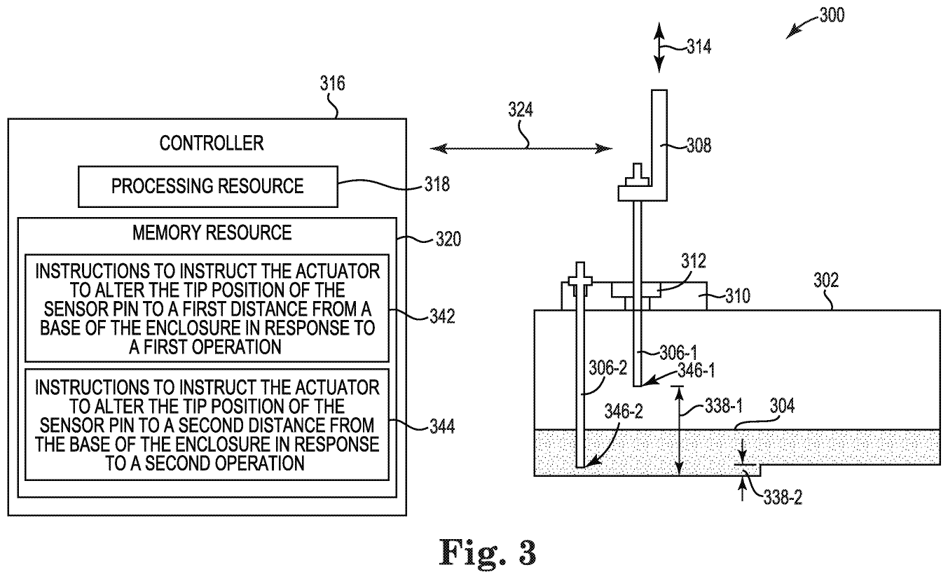

FIG. 3 is an example system 300 for an adjustable print substance detector consistent with the present disclosure. In some examples, the system 300 can include the same or similar elements as system 200 as referenced in FIG. 2 and/or system 100 as referenced in FIG. 1. For example, the system 300 can be part of a printing device and include a print substance reservoir 302 that includes a print substance 304. In addition, the system 300 can include a first sensor pin 306-1 coupled to an actuator 308 to alter the position of the first sensor pin 306-1 within the print substance reservoir 302. In some examples, the system 300 can include a second sensor pin 306-2 that is fixed to a base portion 310. In some examples, the system 300 can include a base portion 310 that can include a seal 312 to prevent the print substance 304 from passing through the aperture to the exterior of the print substance reservoir 302.

As described herein, the actuator 308 can be communicatively coupled to a controller 316 through a communication path 324. In some examples, the controller 316 can send instructions to the actuator 308 through the communication path 324. In other examples, the first sensor pin 306-1 and/or the second sensor pin 306-2 can send sensor data to the controller 316. As used herein, sensor data can include information sensed by the first sensor pin 306-1 and/or the second sensor pin 306-2. For example, the sensor data can include a particular conductivity between electrodes of the first sensor pin 306-1 and/or the second sensor pin 306-2. In other examples, the sensor data can include an indication of the presence or absence of print substance 304 contacting the surface of the first sensor pin 306-1 and/or the second sensor pin 306-2.

In some examples, the first sensor pin 306-1 and the second senor pin 306-2 can be coupled to a sensing circuit. In some examples, the controller 316 can include a sensing circuit and utilize the sensing circuit to analyze the sensor data provided by the first sensor pin 306-1 and/or the second sensor pin 306-2. As used herein, a sensing circuit can include a circuit that can compare an input current or voltage to an output current or voltage from a sensor. For example, an input current or voltage can be applied to the second sensor pin 306-2. In this example, the input current or voltage can be input into the print substance 304 through the second sensor pin 306-2. In this example, the first sensor pin 306-1 can include a voltage or current detector that can be utilized to measure a voltage or current at the first sensor pin 306-1. As described further herein, the presence or absence of print substance 304 can be determined based on a detected voltage or current. As described herein, the first sensor pin 306-1 and/or second sensor pin 306-2 can utilize a voltage or current as a signal to determine a level of the print substance 304. However, other signals can be utilized by the first sensor pin 306-1 and/or second sensor pin 306-2. For example, a waveform signal and/or pulsed signal can be utilized to determine the level of the print substance 304 in a similar way as described herein.

In some examples, the first sensor pin 306-1 can be utilized to apply a voltage or current to the print substance 304 and the second sensor pin 306-2 can be utilized to detect a voltage or current. For example, a voltage or current can be applied to the first sensor pin 306-1. In this example, the second sensor pin 306-2 can include a voltage or current sensor to determine a voltage or current of the print substance 304. In this example, the detected voltage or current at the second sensor pin 306-2 can increase when the first sensor pin 306-1 is in contact with the print substance 304 and decrease when the first sensor pin 306-1 is not in contact with the print substance 304. In some examples, a threshold voltage or threshold current can be utilized to determine when the first sensor pin 306-1 is in contact with the print substance 304. In this way, a more accurate level of the print substance 304 can be determined.

In some examples, the first sensor pin 306-1 can be a sense pin and the second sensor pin 306-2 can be a driver pin. As used herein, a sense pin can be a sensor pin that that is utilized to determine a voltage or current applied within the print substance 304 that is applied by a driver pin (e.g., second sensor pin 306-2, etc.). As used herein, a driver pin can be a pin that is utilized apply an input voltage or current into the print substance 304. In some examples, the sense pin can be coupled to the actuator 308 and the driver pin can be in a fixed location coupled to the base portion 310. In other examples, the sense pin can be in a fixed location and the driver pin can be coupled to the actuator 308. In some examples, the sense pin can include a voltage or current sensor to detect a voltage or current within the print substance 304.

In some examples, the system 300 can utilize the sense pin to determine when the detected voltage or current by the sense pin exceeds a threshold value (e.g., ink threshold value, etc.). For example, the detected voltage or current can be below the threshold value when the sense pin is not positioned within or in contact with the print substance 304 since the applied voltage or current from the driver pin is not received by the sense pin when the sense pin is not in contact with the print substance 304. In this example, the detected voltage or current by the sense pin can be above the threshold value when the sense pin is in contact with the print substance 304 since the applied voltage or current applied by the driver pin is received by the sense pin through the print substance 304.

In some examples, the first sensor pin 306-1 can be adjustable utilizing the actuator 308 as described herein. In this way, the first sensor pin 306-1 can be utilized to monitor relatively minor changes in the level of print substance 304 within the print substance reservoir 302. In these examples, the second sensor pin 306-2 can be position in a fixed location as described herein. For example, the second sensor pin 306-2 can be positioned in a fixed location with a fixed tip 346-2 position within the enclosure of the print substance reservoir 302.

Although a single first sensor pin 306-1 and a single second sensor pin 306-2 are illustrated in FIG. 3, examples of the present disclosure are not so limited. For example, the system 300 can include a plurality of sensor pins utilized in a similar way as the second sensor pin 306-2. For example, the system 300 can include a plurality of fixed sensor pins that are fixed at different levels within the print substance reservoir 302. In this example, the plurality of fixed sensors can be positioned at different threshold levels (e.g., maximum level, minimum level, etc.) within the print substance reservoir 302. In addition, the system 300 can include a plurality of adjustable sensor pins similar to the first sensor pin 306-1. For example, the actuator 308 can be coupled to a plurality of sensor pins to adjust the plurality of sensor pins. In some examples, the plurality of sensor pins coupled to the actuator 308 can be at different levels within the print substance reservoir 302. In some examples, the plurality of sensor pins coupled to the actuator can be adjusted independently or simultaneously.

In some examples, the controller 316 can be the same or similar device as controller 216 as referenced in FIG. 2, and/or controller 116 as referenced in FIG. 1. For example, the controller 316 can include a processing resource 318 and a memory resource 320 storing instructions 342, 344 that can be executed by the processing resource 318 to perform particular functions. The controller 316 can include instructions 342, that when executed by a processing resource 318 can instruct the actuator 308 to alter the tip 346-1 position of the first sensor pin 306-1 to a first distance 338-1 from a base of the enclosure (e.g., print substance reservoir 302, etc.) in response to a first operation. In some examples, the enclosure can be a storage location of the print substance reservoir 302. For example, the enclosure can be utilized to store the print substance 304 as described herein.

As described herein, the first sensor pin 306-1 can be coupled to the actuator 308 and be adjustable within the enclosure of the print substance reservoir 302. For example, the actuator 308 can move the first sensor pin 306-1 in the directions of double arrow 314. In this way, a tip 346-1 of the first sensor pin 306-1 can be adjusted to different levels within the enclosure of the print substance reservoir 302. As described herein, the actuator 308 can adjust the first sensor pin 306-1 such that the tip 346-1 of the first sensor pin 306-1 is positioned at a particular level based on a corresponding operation to be performed. As described herein, the operation can be a fill operation, a drain operation, a storage operation, and/or other type of operation that can alter a level of the print substance 304 within the enclosure of the print substance reservoir 302.

In some examples, the first operation can be a fill operation. As described herein, a fill operation can include an action to add print substance 304 to the print substance reservoir 302. In some examples, the actuator 308 can receive an indication from the controller 316 through the communication path 324 that the first operation is a fill operation. In these examples, the actuator 308 can adjust the tip 346-1 of the first sensor pin 306-1 to the first distance 338-1. In these examples, the fill operation can be performed and the tip 346-1 of the first sensor pin 306-1 can determine the presence of the print substance 304 at the completion of the fill operation. In other examples, the notification can be generated by a sensing circuit coupled to the controller 316.

In some examples, the first distance 338-1 can correspond to a predicted level of the print substance at the completion of the fill operation. In this way, the tip 346-1 of the first sensor pin 306-1 can determine the presence of the print substance 304 upon the completion of the fill operation. That is, the first sensor pin 306-1 can be utilized to indicate when the first operation and/or the fill operation is complete. In other examples, the first distance 338-1 can correspond to a threshold level of print substance 304. For example, the first distance 338-1 can correspond to a level near an overflow level. In this example, the tip 346-1 of the first sensor pin 306-1 can be utilized to generate a notification when the tip 346-1 detects the presence of the print substance 304. In this way, the system 300 can prevent the enclosure of the print substance reservoir 302 from being overfilled with the print substance 304.

The controller 316 can include instructions 344, that when executed by a processing resource 318 can instruct the actuator 308 to alter the tip 346-1 position of the first sensor pin 306-1 to a second distance 338-2 from the base of the enclosure in response to a second operation. In some examples, the second operation can be a drain operation. As described herein, the drain operation can include an action to remove a portion of the print substance 304 from the enclosure of the print substance reservoir 302. For example, the drain operation can be an action to transport a portion of the print substance 304 to a different area of the printing device or reclaim the print substance 304 from the print substance reservoir 302. In some examples, the actuator 308 can receive an instruction from the controller 316 that the second operation is a drain operation. In these examples, the actuator 308 can alter the first sensor pin 306-1 such that the tip 346-1 is positioned at a second distance 338-2.

In some examples, the second distance 338-2 can be a predicted level of the print substance 304 when the drain operation is completed. For example, the drain operation can be a particular quantity of print substance that can correspond to a particular level being removed from the enclosure of the print substance reservoir 302. In this way, the tip 346-1 of the first sensor pin 306-1 can be utilized to determine when the second operation and/or a drain operation has been completed. In other examples, the second distance 338-2 can be a low level threshold for the enclosure of the print substance reservoir 302. For example, the tip 346-1 of the first sensor pin 306-1 can be positioned to provide a notification when the first sensor pin 306-1 detects the absence of print substance 304 to prevent a level of the print substance 304 from falling below the low level threshold, which can damage the print substance reservoir 302 and/or a system utilized to drain the print substance reservoir 302 (e.g., pumps, etc.).

As described herein, the first sensor pin 306-1 can provide a notification when the first sensor pin 306-1 detects print substance 304 at a fill level during a fill operation. As used herein, the fill level can be a predicted level of print substance 304 within the print substance reservoir 302 after print substance 304 is added during a fill operation. In addition, the first sensor pin 306-1 can provide a notification when the first sensor pin 306-1 detects the absence of print substance 302 at a drain level during a drain operation. As used herein, the drain level can be a level of print substance 304 within the print substance reservoir 302 after the print substance 304 is removed during the drain operation.

The system 300 can be part of a printing device or utilized by a printing device to more accurately monitor a level of print substance 304 within a print substance reservoir 302. In addition, the system 300 can be utilized to more closely monitor changes in the level of the print substance 304 within the print substance reservoir 302 by continually adjusting the level of the sensor pin 306 to the level of the print substance 304. In addition, the system 300 can be utilized to more accurately determine when the level of the print substance 304 exceeds or falls below a threshold level.

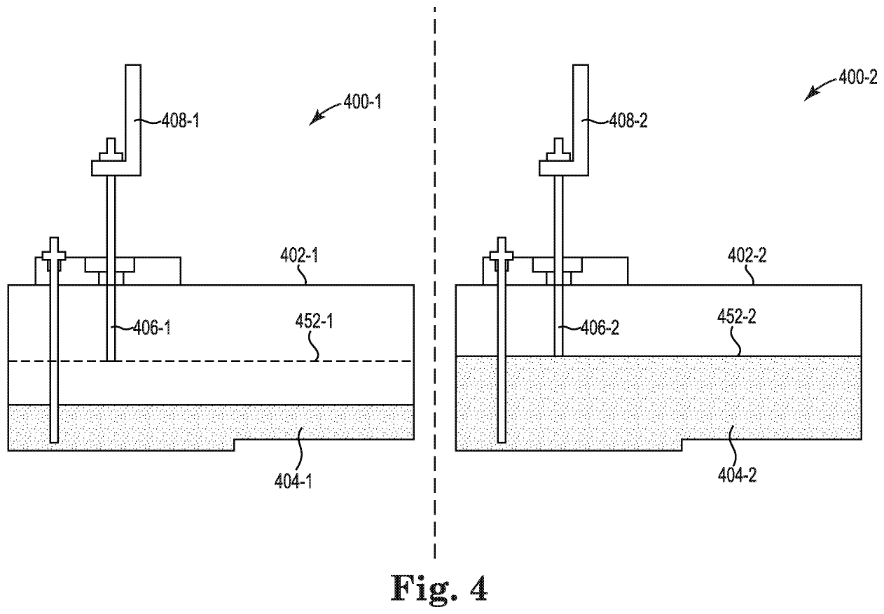

FIG. 4 is an example system 400-1, 400-2 for an adjustable print substance detector for a fill operation consistent with the present disclosure. In some examples, the system 400-1, 400-2 can include the same or similar elements as system 300 as referenced in FIG. 3, system 200 as referenced in FIG. 2 and/or system 100 as referenced in FIG. 1. In some examples, the system 400-1 can be a representation at a first time and the system 400-2 can be a representation at a second time. For example, the first time can be prior to an operation and the second time can be upon completion of the operation. In some examples, the operation can be a fill operation to increase a quantity of prints substance 404-1, 404-2.

In some examples, the actuator 408-1 can alter the position of the sensor pin 406-1 to a level 452-1 when there is an indication of a fill operation. For example, a controller can instruct the actuator 408-1 to alter the distance of the sensor pin 406-1 to a fill level based on an indication of the fill operation. As used herein, a fill level can include a level within the print substance reservoir 402-1 that is predicted to be the level of the print substance 404-1 after the fill operation. Thus, the level 452-1 can be a level that is relatively higher than a current level of the print substance 404-1 within the print substance reservoir 402-1. As described herein, the sensor pin 406-1 can be adjusted to the level 452-1 based on a determination of a quantity of print substance 404-1 to be added during the fill operation. In this way, the sensor pin 406-1 can be utilized to determine when the fill operation is complete.

The system 400-2 can illustrate a time when the fill operation is complete. For example, the system 400-2 can illustrate that print substance 404-2 has reached the level 452-2 and is interacting with a portion of the sensor pin 406-2. In this way, the sensor pin 406-2 can provide a notification that the level of the print substance 404-2 has reached the level 452-2 and/or a tip portion of the sensor pin 406-2.

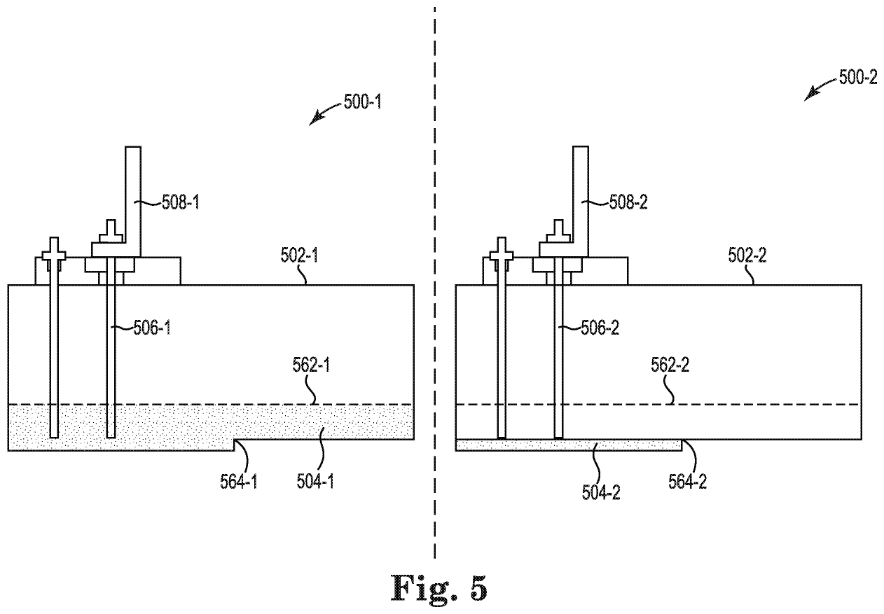

FIG. 5 is an example system 500-1, 500-2 for an adjustable print substance detector for a drain operation consistent with the present disclosure. In some examples, the system 500-1, 500-2 can include the same or similar elements as system 400-1, 400-2 as referenced in FIG. 4, system 300 as referenced in FIG. 3, system 200 as referenced in FIG. 2 and/or system 100 as referenced in FIG. 1. In some examples, the system 500-1 can be a representation at a first time and the system 500-2 can be a representation at a second time. For example, the first time can be prior to an operation and the second time can be upon completion of the operation. In some examples, the operation can be a drain operation.

In some examples, the actuator 508-1 can alter the position of the sensor pin 506-1 to a level 564-1 when there is an indication of a drain operation. Thus, the level 564-1 can be a level that is relatively lower than a current level 562-1 of the print substance 504-1 within the print substance reservoir 502-1. As described herein, the sensor pin 506-1 can be adjusted to the level 564-1 based on a determination of a quantity of print substance 504-1 to be removed during the drain operation. In this way, the sensor pin 506-1 can be utilized to determine when the drain operation is complete.

The system 500-2 can illustrate a time when the drain operation is complete. For example, the system 500-2 can illustrate that print substance 504-2 has reached the level 564-2 and is no longer interacting with a portion of the sensor pin 506-2. In this way, the sensor pin 506-2 can provide a notification that the level of the print substance 504-2 has reached the level 546-2 and/or a tip portion of the sensor pin 506-2.

The above specification, examples and data provide a description of the method and applications and use of the system and method of the present disclosure. Since many examples can be made without departing from the spirit and scope of the system and method of the present disclosure, this specification merely sets forth some of the many possible example configurations and implementations.

What is claimed:

1. A print substance detector, comprising:
a sensor pin;
an actuator coupled to the sensor pin to adjust a distance between a surface of the sensor pin and a base portion of a print substance reservoir; and
a controller to send instructions to the actuator to adjust the distance of the sensor pin based on an indication of an operation associated with the print substance reservoir.

2. The print substance detector of claim 1, wherein the operation associated with the print substance reservoir includes one of a fill operation and a drain operation.

3. The print substance detector of claim 2, wherein the controller alters the distance of the sensor to a fill level based on an indication of the fill operation.

4. The print substance detector of claim 3, wherein the controller includes instructions to provide a notification when the sensor detects print substance at the fill level during the fill operation.

5. The print substance detector of claim 2, wherein the controller alters the distance of the sensor to a drain level based on an indication of the drain operation.

6. The print substance detector of claim 5, wherein the controller includes instructions to provide a notification when the sensor detects print substance is at the drain level during the drain operation.

7. A system, comprising:
a print substance reservoir;
an actuator coupled to the print substance reservoir;
a sensor pin extending from the actuator to an interior portion of the print substance reservoir; and
a controller comprising instructions to:
determine an initiation of an operation to change a level of print substance within the print substance reservoir;
activate the actuator to alter a level of the sensor pin within the print substance reservoir; and
determine when the operation is completed based on the sensor pin interacting with the print substance within the print substance reservoir.

8. The system of claim 7, wherein the operation to change the level of print substance includes an operation to fill the print substance reservoir by increasing the level of print substance from a first level to a second level.

9. The system of claim 8, wherein the instructions to activate the actuator to alter the level of the sensor pin includes instructions to alter the level of the sensor pin to the second level when the operation is a fill operation.

10. The system of claim 7, wherein the operation to change the level of print substance includes an operation to drain the print substance reservoir by decreasing the level of print substance from a first level to a second level.

11. The system of claim 10, wherein the instructions to activate the actuator to alter the level of the sensor pin includes instructions to alter the level of the sensor pin to the second level when the operation is a drain operation.

12. The system of claim 7, wherein the sensor pin extends from an exterior portion of the print substance reservoir to the interior portion of the print substance reservoir.

13. A print substance reservoir, comprising:
an enclosure to store a print substance;
a first aperture to receive a first sensor pin;
a second aperture to receive a second sensor pin;
an actuator coupled to the first sensor pin to alter a tip position of the first sensor pin within the enclosure; and
a controller comprising instructions to:
instruct the actuator to alter the tip position of the first sensor pin to a first distance from a base of the enclosure in response to a first operation; and
instruct the actuator to alter the tip position of the first sensor pin to a second distance from the base of the enclosure in response to a second operation.

14. The print substance reservoir of claim 13, wherein the second sensor pin is positioned in a fixed location with a fixed tip position within the enclosure.

15. The print substance reservoir of claim 13, wherein the second sensor pin is a driver pin and the first sensor pin is a sensing pin.
